(19) United States
(12) Patent Application Publication
(10) Pub. No.: US 2025/0368478 A1
(43) Pub. Date: Dec. 4, 2025

(54) LIFT CRANE ASSEMBLY FOR A WIND TURBINE NACELLE

(71) Applicant: The Carlson Company, Inc., Park City, KS (US)

(72) Inventor: Rodney Bruntz, Valley Center, KS (US)

(21) Appl. No.: 18/733,566

(22) Filed: Jun. 4, 2024

(51) Int. Cl. B66C 23/20; F03D 13/10

(52) U.S. Cl. CPC B66C 23/207; F03D 13/122; F03D 13/139; F05B 2230/61

(57) ABSTRACT

According to one embodiment, a crane configured for a wind turbine having a nacelle with a nacelle hatch may include a post configured to couple the crane with the nacelle of the wind turbine, a step coupled with the post, the step sized and shaped such that at least a portion of the step is positioned and located below the nacelle hatch when the post is coupled with the nacelle of the wind turbine, a column extending away from the step, and an arm coupled with the column, wherein the arm is selectively rotatable about the column to position a distal end of the arm above the nacelle hatch.

### CROSS-REFERENCE TO RELATED APPLICATIONS

None.

### BACKGROUND OF THE INVENTION

The present invention relates generally to a crane for a wind turbine. More specifically, the present invention relates to a crane configured to lift, lower, and move pitch motors and other objects for a wind turbine.

Wind turbines include a variety of motor and braking mechanisms to move and hold various components of the wind turbine in a particular direction, angle, or orientation. One such motor and braking system is the pitch control system, which is responsible for rotating the blades of the wind turbine about their longitudinal axis (e.g., to control the lift generated by the blades). For example, a pitch control system may include a plurality of pitch motors that are positioned and located in the rotor of the wind turbine and coupled with at least one of the blades. When the pitch motors are operated, each of the pitch motors may rotate one or more of the blades about their longitudinal axis relative to the rotor of the wind turbine.

Pitch motors have a finite life and, thus, require replacement periodically. Conventional methods for replacing a pitch motor involve maintenance technicians lifting a replacement pitch motor through a roof hatch and onto the roof of the nacelle. Once the replacement pitch motor is placed on the roof of the nacelle, the maintenance technicians carry the replacement pitch motor across the roof and down to an access panel positioned and located on the housing of the rotor. After opening the access panel, the maintenance technicians move the replacement pitch motor through the access panel, uninstall the previous pitch motor, and install the replacement pitch motor. After the replacement pitch motor is installed, the maintenance technicians carry the uninstalled pitch motor through the access panel and to the roof hatch on the nacelle. Finally, the maintenance technicians may lower the uninstalled pitch motor through the roof hatch.

However, conventional methods for replacing pitch motors have several deficiencies. For example, in some exemplary embodiments, pitch motors can weigh about 250 lbs. As a result, maintenance technicians must take precautions to avoid injuries and strains when lifting the pitch motors. In addition to being relatively heavy, the pitch motors can also be relatively large in size. Thus, maintenance technicians may find it difficult or cumbersome to carry the pitch motors (e.g., to the access panel on the rotor). In addition, there may be limited space available in the nacelle. Thus, maintenance technicians may find it difficult to find a suitable place to stand while maneuvering the pitch motors through the roof hatch.

Various other different parts and components of wind turbines also require periodic repair and replacement. In addition to pitch motors, these parts and components may need to be lifted to or from the nacelle roof. Further, certain repairs and maintenance that occurs outside of the nacelle may require certain equipment, tools, and/or machinery that must be transported from the nacelle to the roof of the nacelle. These various parts, components, equipment, tools, and machinery need to be lifted through the nacelle hatch, which similar to pitch motors described above, can be difficult to lift through the hatch due to their size, shape and/or weight.

Accordingly, there is a need for an apparatus that is adapted to help with lifting, raising, installing, or replacing a pitch motor in a wind turbine, as well as other parts, components, equipment, tools, and/or machinery used in a wind turbine. In addition, a need exists for a method of lifting, raising, installing, or replacing a pitch motor and other objects for a wind turbine that does not require maintenance technicians to manually lift the pitch motor or other object.

Accordingly, the present invention has for its object to obviate or at least reduce the above-stated problems with known methods for replacing a pitch motor.

### SUMMARY OF THE INVENTION

The present invention is directed generally to a crane for a wind turbine. In addition, the present invention is also directly generally to a method for lifting a pitch motor or other object for a wind turbine. Through various means, the crane and the method may help to ease the burden associated with lifting a pitch motor or other object as currently known in the art.

According to one embodiment of the present invention, a crane configured for a wind turbine with a nacelle having a nacelle hatch may include a post configured to couple the crane with the nacelle of the wind turbine, a step coupled with the post, the step sized and shaped such that at least a portion of the step is positioned and located below the nacelle hatch when the post is coupled with the nacelle of the wind turbine, a column extending away from the step, and an arm coupled with the column, wherein the arm is selectively rotatable about the column to position a distal end of the arm above the nacelle hatch. In some such embodiments, the column extends along a first axis, and the post extends along a second axis that is oriented parallel to the first axis. In a further embodiment, an outer edge of the step is positioned and located between about 5 inches and about 18 inches from the first axis. In another embodiment, the column includes a lower section and an upper section coupled together by a joint, and the joint is received in each of the upper section and the lower section. In one embodiment, the crane further includes a gasket assembly coupled with the column and configured to selectively engage with the nacelle of the wind turbine. In another embodiment, the arm is configured to couple with a winch proximate to the distal end. In yet another embodiment, the crane further includes a shaft having a lower region and an upper region, wherein the lower region is coupled with the column, a bearing coupled with the upper region, and a housing coupled with the arm and supported on the shaft by the bearing.

According to another embodiment of the present invention, the crane may include a post oriented along a first axis, a platform supported by the post, a column coupled with the platform and oriented along a second axis, and an arm protruding outwardly from the column to a distal end, wherein an aperture extends through the arm proximate to the distal end, and wherein the post and the column are positioned and located on the platform such that a distance between the first axis and the second axis is between about 42% and about 72% of a total length of the platform. In one such embodiment, the distance between the first axis and the second axis is between about between about 2 inches and about 13 inches. In another embodiment, a distance between the aperture and the second axis is between about 5 inches and about 25 inches. In yet another embodiment, the aperture is positioned and located a first distance from the second axis, an outer edge of the platform is positioned and located a second distance from the second axis, and the first distance is greater than the second distance. In one embodiment, the crane includes treads formed on an upper surface of the platform. In other embodiments, the column includes an upper section and a lower section coupled together by a joint, and the joint includes a flange configured to support the upper section on the joint. In one such embodiment, the flange is further configured to support the joint on the lower section.

In yet a further embodiment of the present invention, a method of lifting a pitch motor may include the steps of selecting a wind turbine having a nacelle housing and a hatch extending through the nacelle housing, coupling a crane with the wind turbine such that the crane extends through the nacelle housing, coupling a winch with the crane, coupling the pitch motor with the winch, and operating the winch to lift the pitch motor through the hatch. In one such embodiment, the step of coupling the crane with the wind turbine includes inserting a lower end of the crane in a bearing casing. In another embodiment, the step of coupling the crane with the wind turbine includes rotating at least one fastener to engage a gasket with the nacelle housing. In one embodiment, the step of coupling the pitch motor with the winch includes rotating an arm of the crane to position the winch above the hatch. In another embodiment, the method further includes steps of rotating an arm of the crane to position the pitch motor over a roof of the nacelle housing, and operating the winch to lower the pitch motor. In yet another embodiment, the step of coupling the crane with the wind turbine includes positioning the crane such that a column extending along a central axis passes through the wind turbine, wherein the central axis is positioned and located between about 4 inches and about 10 inches from an edge the hatch.

Further advantages, features and details of the invention are elucidated on the basis of preferred embodiments thereof, wherein reference is made to the accompanying drawings.

### DESCRIPTION OF THE SEVERAL VIEWS OF THE DRAWINGS

In the accompanying drawings, which form a part of the specification and are to be read in conjunction therewith, like reference numerals are used to indicate like or similar parts in the various views:

FIG. 1 is a partial perspective view of a wind turbine and a crane coupled therewith according to a first embodiment of the present invention;

FIG. 2 is an enlarged top plan view of the wind turbine and the crane of FIG. 1;

FIG. 3 is a cross-sectional front elevation view of the crane of FIG. 1 taken generally about line 3-3 (see FIG. 2) in the direction of the arrows;

FIG. 4 is a perspective view of a step assembly of the crane of FIG. 1;

FIG. 5 is a front elevation view of a lower column section of the crane of FIG. 1;

FIG. 6 is a perspective view of a plate assembly of the crane of FIG. 1;

FIG. 7 is a front elevation view of a joint of the crane of FIG. 1;

FIG. 8 is a front elevation view of a head assembly of the crane of FIG. 1;

FIG. 9 is cross-sectional side elevation view of the head assembly of FIG. 8 taken generally about line 9-9 (see FIG. 8) in the direction of the arrows;

FIG. 10 is a front elevation view of a crane according to a second embodiment of the present invention; and

FIG. 11 is a flow chart of a method for lifting a pitch motor according to a third

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized, and changes can be made without departing from the scope of the present invention.

According to one aspect, the present invention is directed to a lifting device, jib, hoist stand, winch mount, or crane 100 and a method for using the same. Generally, the crane 100 is configured to couple with a wind turbine and to support a hoist or winch configured to lift and lower components of the wind turbine. In one embodiment, the crane may be coupled with the nacelle of a wind turbine, and the crane 100 may be configured to lift, lower, and move a pitch motor. However, it will be appreciated that the crane 100 may also be used with other components of a wind turbine, or the crane 100 may be coupled with another portion of a wind turbine. It will also be appreciated that the crane 100 may be adapted or configured for use with many other types of parts, equipment, components, tools and/or machinery in association with a wind turbine, particularly for lifting and moving such objects through and out of the nacelle portion of the wind turbine. While the following describes the crane 100 configured for use with a pitch motor, the crane 100 may also be suitably used with such other objects.

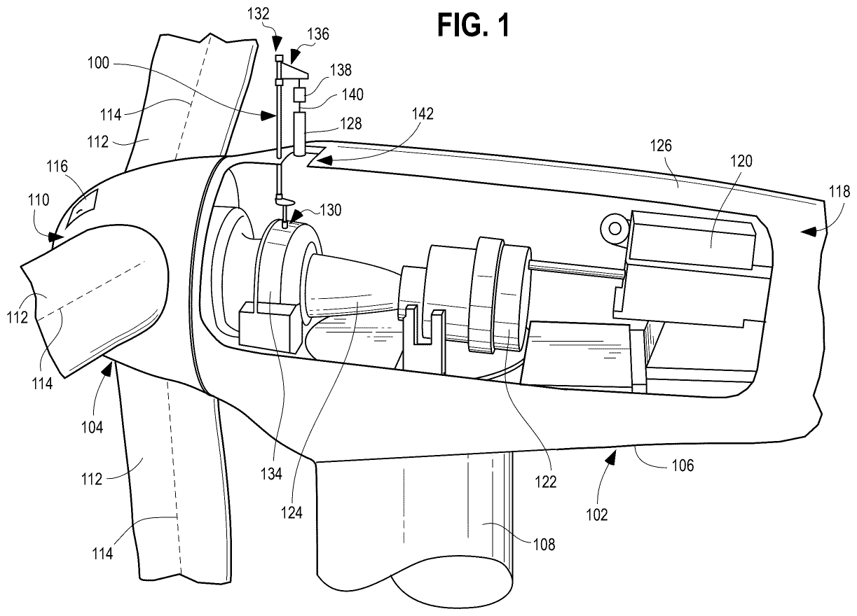

Referring to FIG. 1, an exemplary wind turbine 102 is illustrated with a crane 100 coupled thereto. Generally, the wind turbine 102 includes a rotor 104 rotatably coupled with a nacelle 106 and a tower 108 that supports the nacelle 106. The rotor 104 includes a hub 110, a plurality of blades 112 coupled with the hub 110, and a plurality of pitch motors (not illustrated) positioned and located in the hub 110 for selectively rotating the blades 112 about their longitudinal axis 114 relative to the hub 110. In addition, a service hatch, door, or access panel 116 may be positioned and located on the hub 110 for allowing maintenance technicians to access the pitch motors. The nacelle 106 may include a nacelle housing 118 (partially hidden in FIG. 1) that maintenance technicians may enter for accessing the mechanical and electrical components of the nacelle 106. For example, the nacelle housing 118 may enclose a generator 120, a gear box 122 operably coupled with the generator 120, and a shaft 124 configured to transmit rotational power from the rotor 104 to the gear box 122. The tower 108 may be an elongated structure that is coupled with the nacelle 106 such that the nacelle 106 is selectively rotatable relative to the tower 108. However, other configurations for the wind turbine 102 are also foreseeable and considered within the scope of the present invention.

The crane 100 may be configured for use in connection with the nacelle 106 and may be coupled with the nacelle 106 in a fixed and secured position. As shown in FIG. 1, the crane 100 may extend through a roof 126 of the nacelle housing 118 such that the crane 100 is configured to help lift a pitch motor or other object 128 into or out of the nacelle housing 118. For example, a lower end 130 of the crane 100 may be coupled with the wind turbine 102 inside of the nacelle housing 118, and the crane 100 may extend upwardly from the lower end 130 toward an upper end 132. The lower end 130 may be received and retained in a bearing casing 134 (e.g., via threaded coupling or a friction fit). The bearing casing 134 may be coupled with the nacelle 106 and may enclose a bearing that supports the shaft 124 as the shaft 124 transmits rotational power from the rotor 104 to a gear box 122. However, in other embodiments, the crane 100 may be coupled with another bearing within the nacelle housing 118, such as but not limited to a bearing housing defined into or fixed to a structure within the nacelle housing 118. In yet other embodiments, the crane 100 may be coupled with another suitable portion of the nacelle 106 (e.g., the gear box 122 or a bedplate) or with another suitable portion of the wind turbine 102 (e.g., the tower 108).

As the crane 100 extends upwardly from the lower end 130 to the upper end 132, the crane 100 may extend through the roof 126 of the nacelle housing 118, as illustrated in FIG. 1. Thus, a cantilever or arm 136 protruding outwardly from the upper end 132 of the crane 100 may be positioned and located above the nacelle 106.

The arm 136 may be rotatably coupled with crane 100 and configured to help lift, lower, and move a pitch motor or other object 128. In particular, the arm 136 may be selectively couplable with a hoist or winch 138 configured to selectively retract or dispense a cable 140 therefrom. As the cable 140 is dispensed or retracted, an end of the cable 140 may be raised or lowered, respectively. The cable 140 may be selectively couplable with a pitch motor or other object 128, and the arm 136 may be configured to support the weight of the pitch motor or other object 128. Thus, the pitch motor or other object 128 may be selectively coupled with the cable 140, and the winch 138 may retract or dispense the cable 140 to raise or lower the pitch motor or other object 128, respectively. For example, in some instances, the arm 136 may be rotated about the crane 100 to position the winch 138 over a door or hatch 142 on the roof 126. Then, the cable 140 may be coupled with a pitch motor or other object 128 positioned and located inside the nacelle 106, and the winch 138 may be operated to lift the pitch motor or other object 128 toward the arm 136 and through the hatch 142. Once the pitch motor or other object 128 is lifted through the hatch 142, the arm 136 may be rotated about the crane 100 to position the winch 138 over the roof 126, and the winch 138 may be operated to lower the pitch motor or other object 128. Thus, the arm 136 may be configured to help lift, lower, and move a pitch motor or other object 128.

While the winch 138 is illustrated coupled with the arm 136 in FIG. 1, it will be appreciated that the winch 138 may be coupled with the crane 100 in a variety of other manners. For example, in some configurations, a polyester strap or rigging sling (not illustrated) may couple the winch 138 with the crane 100. The rigging sling may be looped around the crane 100 proximate to the roof 126, and the rigging sling may extend from the crane 100 toward the hub 110. Accordingly, the winch 138 may be used to lower a pitch motor or other object 128 to the access panel 116 or to raise a pitch motor or other object 128 from the access panel 116.

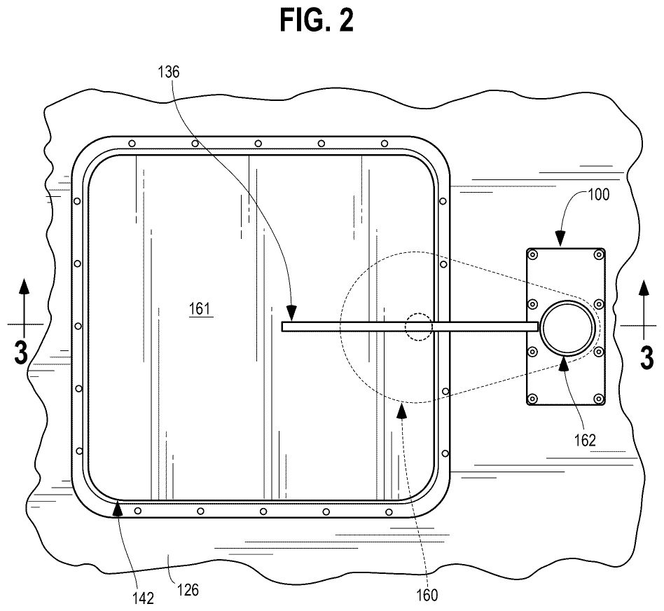

Referring to FIG. 2, the crane 100 may further include a landing, ledge, or step 160 for helping maintenance technicians access the hatch 142. For example, the step 160 may be sized, shaped, and positioned such that at least a portion of the step 160 is directly below the hatch 142. Further, the step 160 may be configured to support a person standing thereon. Thus, maintenance technicians may stand on the step 160 to open a door 161 of the hatch 142 (e.g., by rotating the door 161 outwardly from the hatch 142). Once the door 161 is opened (see, e.g., FIG. 1), maintenance technicians may stand on the step 160 to reach through the hatch 142, climb through the hatch 142, or look through the hatch 142.

The crane 100 may also be configured to help position the winch 138 (see FIG. 1) over the hatch 142 when the winch 138 is coupled with the arm 136. For example, the crane 100 may include a column 162 that extends through the roof 126 proximate to the hatch 142, and the arm 136 may extend outwardly from the column 162. As a result, the arm 136 may be selectively rotated about the column 162 such that the winch 138 is positioned and located above the hatch 142.

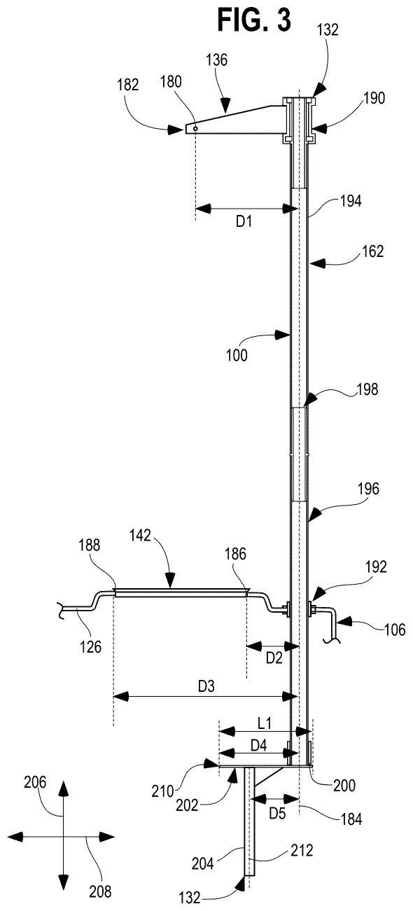

Turning to FIG. 3, the arm 136 may include a hole, bore, or mounting aperture 180 that is configured to couple the arm 136 with the winch 138 (see FIG. 1). The mounting aperture 180 may be a circular-shaped opening that extends through the arm 136 proximate to a distal end 182 of the arm 136. In particular, the mounting aperture 180 may be positioned and located a first distance D1 from a central axis 184 of the column 162. The first distance D1 may be greater than a second distance D2 between an inner edge 186 of the hatch 142 and the central axis 184. However, the first distance D2 may be less than a third distance D3 between an outer edge 188 of the hatch 142 and the central axis 184. Thus, because the first distance D1 is greater than the second distance D2 but less than the third distance D3, the mounting aperture 180 may be positioned and located above the hatch 142. In such an arrangement, an object 128 (such as a pitch motor) suspended from the arm 134 is positioned in general alignment with the hatch 142 and easily moved through the opening of the hatch 142.

For example, the first distance D1 may be between about 5 inches and about 25 inches in one exemplary embodiment, between about 10 inches and about 20 inches in another exemplary embodiment, between about 12 inches and about 18 inches in yet another exemplary embodiment, and about 15 inches in further embodiments. Further, the second distance D2 may be between about 0 inches and about 14 inches in one exemplary embodiment, between about 4 inches and about 10 inches in another exemplary embodiment, and about 7 inches in further embodiments. The third distance D3 may be between about 5 inches and about 45 inches in one exemplary embodiment, between about 15 inches and about 35 inches in another exemplary embodiment, between about 20 inches and about 30 inches in yet another exemplary embodiment, and about 25 inches in further embodiments. However, the foregoing represents only some exemplary embodiments, and in other instances, the first distance D1, the second distance D2, and the third distance D3 may be longer or shorter distances.

As further illustrated in FIG. 3, the column 162 may be an elongated assembly extending along a central axis 184 to couple the arm 136 with the step 160. In particular, the column 162 may support a head assembly 190 coupled with the arm 136, and the column 162 may extend downwardly through the roof 126 of the nacelle 106 to the step 160. As the column 162 extends through the roof 126, the column 162 may engage with a clamp assembly, gasket assembly, or plate assembly 192 of the crane 100 to seal the roof 126 and to support the column 162 on the roof 126.

According to one embodiment, the column 162 may include an upper column section 194 and a lower column section 196 that are coupled together with a joint 198. The upper column section 194 and the lower column section 196 may each be tubular-shaped and may be oriented along the central axis 184 of the column 162. The upper column section 194 may extend downwardly from the head assembly 190 and may engage with the joint 198 such that the joint 198 is received in the upper column section 194. The lower column section 196 may support the joint 198 and may extend downwardly from the joint 198 to the step 160. More specifically, the joint 198 may be received in the lower column section 196 such that the upper column section 194 and the lower column section 196 are coupled with one another and oriented parallel with one another. As the lower column section 196 extends downwardly from the joint 198, the lower column section 196 may be received by the step 160 to couple the column 162 with the step 160. However, in some suitable embodiments, the column 162 may include additional column sections that are coupled together by additional joints, or in yet other suitable embodiments, the column 162 may comprise a single unitary component. It is also recognized that the column 162 may have any suitable cross-sectional shape, including but not limited to, circular, rectangular, ovoid, triangular, or other shape.

The step 160 may be configured to receive the column 162 and couple the crane 100 with the nacelle 106. For example, the step 160 may generally include a socket or fitting 200 configured to receive the lower column section 196, a rung or platform 202 configured for a maintenance technician to stand thereon, and a leg or post 204 configured to couple the step 160 with the bearing casing 134 (see FIG. 1). The fitting 200 may be a cylindrical-shaped tube sized and shaped to receive the lower column section 196 therein. The fitting 200 may protrude from the platform 202 generally in a vertical direction 206 (e.g., a direction oriented parallel to the central axis 184). In contrast, the platform 202 may extend generally in a horizontal direction 208 such that at least a portion of the platform 202 is positioned and located below the hatch 142. For example, the platform 202 may be sized and shaped such that an outer end 210 of the platform 202 is positioned and located a fourth distance D4 from the central axis 184 of the column 162. The fourth distance D4 may be greater than the second distance D2 but less than the third distance D3. Thus, the outer end 210 of the platform 202 may be positioned and located below the hatch 142 between the inner edge 186 and the outer edge 188. In addition, the fourth distance D4 may be less than the first distance D1 such that the mounting aperture 180 is positioned and located further from the central axis 184 than the outer edge 188 of the platform 202. As a result, the platform 202 may be sized and shaped such that the outer edge 188 of the platform 202 is not positioned and located below the winch 138. The fourth distance D4 may be between about 5 inches and about 18 inches in one exemplary embodiment, between about 8 inches and about 15 inches in another exemplary embodiment, between about 11 inches and about 12 inches in yet another exemplary embodiment, and about 12 inches in further embodiments. However, the foregoing represents only some exemplary embodiments, and in other instances, the fourth distance D4 may be a longer or shorter distance.

The step 160 may be configured to help position the crane 100 such that the column 162 extends through a suitable portion of the roof 126. For example, the post 204 may support the crane 100 on the nacelle 106, and the post 204 may extend along a post axis 212 that is oriented parallel to the central axis 184. The post 204 and the fitting 200 may be positioned and located on the platform 202 such that the post axis 212 and the central axis 184 of the column 162 are positioned and located a fifth distance D5 from one another when the column 162 is received in the fitting 200. The fifth distance D5 may be between about 0 inches and about 15 inches in one exemplary embodiment, between about 2 inches and about 13 inches in another exemplary embodiment, between about 5 inches and about 10 inches in yet another exemplary embodiment, and about 7.5 inches in further embodiments. Moreover, the fifth distance D5 may be between about 42% and about 72% of a total length L1 of the platform 202 in one exemplary embodiment, between about 47% and about 67% of the total length L1 of the platform 202 in another exemplary embodiment, between about 52% and about 62% of the total length L1 of the platform 202 in yet another exemplary embodiment, and about 57% of the total length L1 of the platform 202 in further embodiments. The total length of the platform L1 may be between about 7 inches and about 20 inches in one exemplary embodiment, between about 10 inches and about 17 inches in another exemplary embodiment, between about 13 inches and about 14 inches in yet another exemplary embodiment, and about 13 inches in further embodiments. However, the foregoing represents only some exemplary embodiments, and in other instances, the fifth distance D5 and/or the total length of the platform L1 may be longer or shorter.

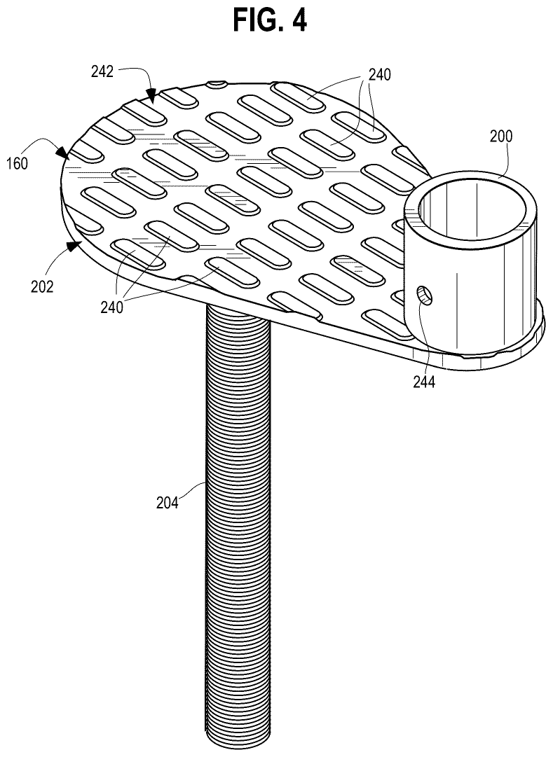

In FIG. 4, the step 160 is illustrated in further detail. As illustrated, the post 204, the platform 202, and the fitting 200 may be formed together as a unitary component (e.g., via welding). The post 204 may be a rod that includes threads for coupling the step 160 with the bearing casing 134 (see FIG. 1), although other means for coupling the post 204 and the bearing casing 134 are foreseeable (e.g., a friction fit, fastening means, welding, etc.) and considered within the scope of the present invention. The platform 202 may be a generally flat plate that includes treads 240 embossed on an upper surface 242 to help provide traction for maintenance technicians standing on the platform 202. The treads 240 may be elongated protrusions formed in a parallel pattern on the upper surface 242, although other suitable tread patterns (e.g., diamond, two-bar, or three-bar) are also contemplated and considered within the scope of the present invention. The fitting 200 may be a cylindrical-shaped tube that protrudes upwardly from the upper surface 242 of the platform 202. The fitting 200 may include a first fastening aperture 244 configured to receive a pin (not illustrated) extending through the fitting 200 in a radial direction. When a pin is received in the first fastening aperture 244, the pin may extend through the fitting 200 to help retain the column 162 in the fitting 200, although other means for coupling the fitting 200 and the column 162 are also contemplated and considered within the scope of the present invention.

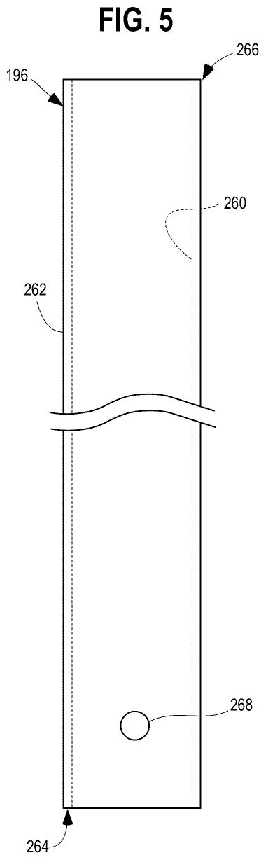

FIG. 5 illustrates the lower column section 196 in further detail. As illustrated, the lower column section 196 may be a cylindrical-shaped tube with an inner diameter 260 and an outer diameter 262 that each extend from a first end 264 to a second end 266. The lower column section 196 may be configured to couple with the fitting 200 (see, e.g., FIG. 4) proximate to the first end 264 and may be configured to couple with the joint 198 (see, e.g., FIG. 3) proximate to the second end 266. For example, the outer diameter 262 may be sized and shaped to be received in the fitting 200. In addition, a second fastening aperture 268 that is sized and shaped to receive a pin (not illustrated) may extend through the lower column section 196 proximate to the first end 264. Accordingly, a pin extended through the first fastening aperture 244 (see FIG. 4) may be received in the second fastening aperture 268 to couple the lower column section 196 with the step 160.

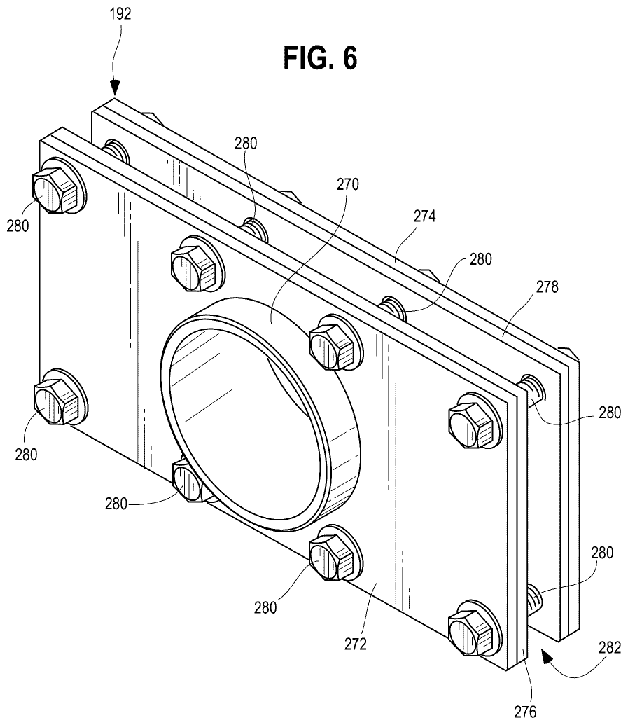

As illustrated in FIG. 6, the plate assembly 192 may generally include a socket liner 270, a first plate 272, a second plate 274, a first gasket 276, and a second gasket 278 that are configured to seal the nacelle 106 (see, e.g., FIG. 1) as the column 162 (see, e.g., FIG. 3) extends through the roof 126. In particular, the socket liner 270 may be a sleeve, bushing, or tube extending through the plate assembly 192. The socket liner 270 may be sized and shaped to engage with the outer diameter 262 of the lower column section 196 to support the lower column section 196 and to seal the interface between the plate assembly 192 and the lower column section 196. The first plate 272 and the second plate 274 may engage with the first gasket 276 and the second gasket 278 to seal the interface between the plate assembly 192 and the roof 126 (see, e.g., FIG. 3). For example, the first plate 272 and the second plate 274 may be oriented parallel with one another and positioned and located on opposing sides of the plate assembly 192. A plurality of fasteners 280 may extend through the first plate 272 and the second plate 274. The plurality of fasteners 280 may be selectively rotatable to move the first plate 272 and the second plate 274 toward or away from one another. As the first plate 272 and the second plate 274 move relative to one another, a gap 282 positioned and located between the plates 272, 274 may increase or decrease in size. The first gasket 276 may be coupled with the first plate 272 adjacent to the gap 282, and the second gasket 278 may be coupled with the second plate 274 adjacent to the gap 282. Thus, the roof 126 may be positioned and located in the gap 282, and the fasteners 280 may be rotated to move the plates 272, 274 toward the roof 126. As the plates 272, 274 move toward the roof 126, the plates 272, 274 may compress the gaskets 276, 278 on opposing sides of the roof 126 to seal the interface between the roof 126 and the plate assembly 192.

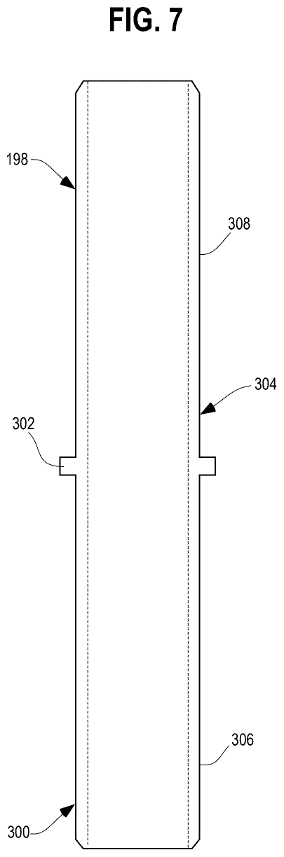

Turning to FIG. 7, the joint 198 may include a tube 300 with a flange 302 extending outwardly from an outer surface 304 of the tube 300. A lower portion 306 of the tube 300 may be positioned and located below the flange 302 and may be configured to receive the lower column section 196 (see, e.g., FIG. 5). In contrast, an upper portion 308 of the tube 300 may be positioned and located above the flange 302 and may be configured to receive the upper column section 194 (see FIG. 3). For example, the outer surface 304 of the tube 300 may be smaller than the inner diameter 260 of the lower column section 196 and an inner diameter of the upper column section 194. Thus, the lower portion 306 and the upper portion 308 may be received in the lower column section 196 and the upper column section 194, respectively. In contrast to the tube 300, the flange 302 may be larger than the outer diameter 262 of the lower column section 196. As a result, the flange 302 may abut the lower column section 196, and the joint 198 may be supported by the flange 302, which rests on top of the lower column section 196. Similarly, the flange 302 may be larger than an outer diameter of the upper column section 194. As a result, the upper column section 194 may abut the flange 302, and the flange 302 may support the upper column section 194 as the upper column section 194 rests thereon.

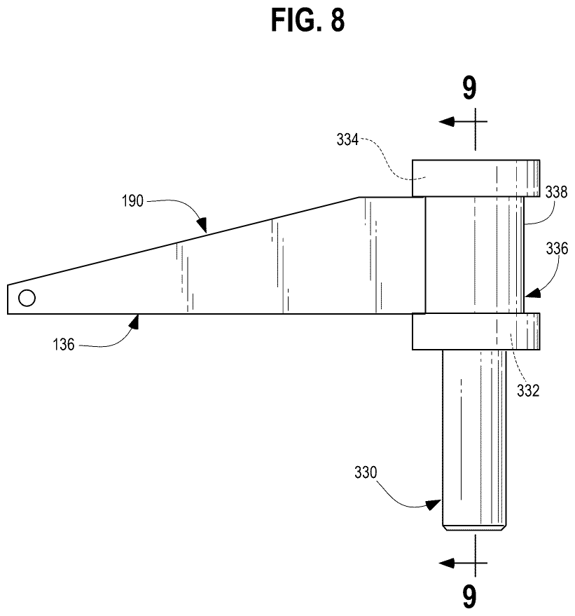

Referring to FIG. 8, the head assembly 190 may be configured to rotatably couple the arm 136 with the upper column section 194 (see FIG. 3). For example, the head assembly 190 may generally include a bearing shaft 330, a first bearing 332, a second bearing 334, and a bearing housing 336. The bearing shaft 330 may be configured to couple with the upper column section 194 to support the head assembly 190 on the upper column section 194. The first bearing 332 and the second bearing 334 may be coupled with the bearing shaft 330 and the bearing housing 336 such that the bearing housing 336 is selectively rotatable about the bearing shaft 330. The bearing housing 336 may include a central portion 338 coupled with the bearings 332, 334, and the arm 136 may extend outwardly from the central portion 338. Thus, the head assembly 190 may be configured to rotatably couple the arm 136 with the upper column section 194.

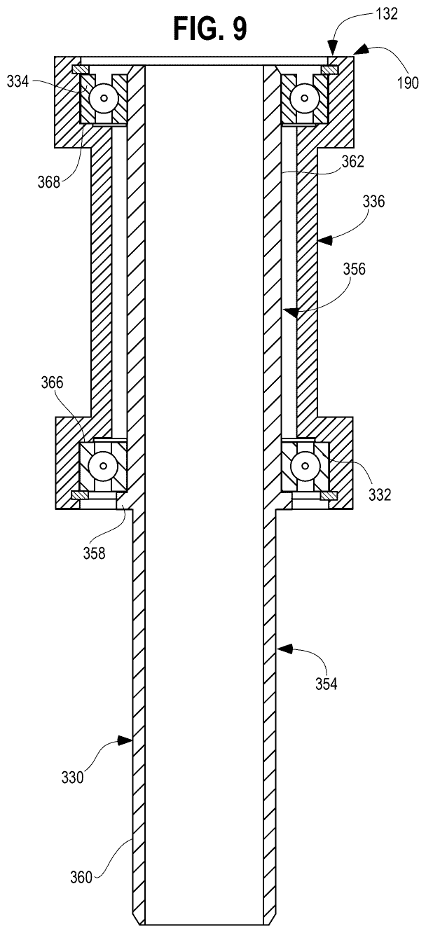

As best illustrated in FIG. 9, the bearing shaft 330 may be an elongated, tubular body with a lower region 354 and an upper region 356 separated by a flange or lip 358. The lower region 354 may include a first outer diameter 360 that is sized and shaped such that the lower region 354 is receivable in the upper column section 194 (see FIG. 3). In contrast, the lip 358 may extend outwardly from the first outer diameter 360 such that the lip 358 supports the bearing shaft 330 on top of the upper column section 194. The upper region 356 may include a second outer diameter 362 that is sized and shaped to extend through the first bearing 332 and the second bearing 334 such that the bearings 332, 334 are positioned and located concentrically with the bearing shaft 330 and the central axis 184 of the column 162 (see, e.g., FIG. 3).

The first bearing 332 and the second bearing 334 may be configured to rotatably couple the bearing housing 336 with the bearing shaft 330 such that arm 136 (see, e.g., FIG. 8) is selectively rotatable about the column 162. In particular, the first bearing 332 may be supported on the lip 358, and the first bearing 332 may engage with a first groove 366 on the bearing housing 336 to support the bearing housing 336. The second bearing 334 may be supported by a second groove 368 positioned and located on the bearing housing 336 such that the second bearing 334 is positioned and located proximate to the upper end 132 of the crane 100. The first bearing 332 and the second bearing 334 may engage with the bearing housing 336 such that the bearing housing 336 and the arm 136 are selectively rotatable about the bearing shaft 330 and the central axis 184 of the column 162.

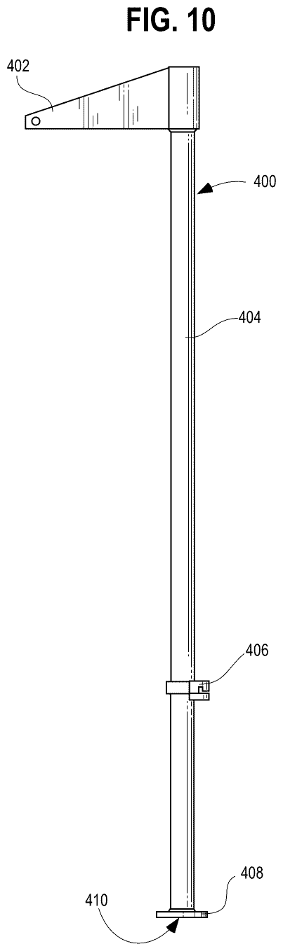

FIG. 10 illustrates an alternative embodiment of a crane 400. Similar to the crane 100, the crane 400 includes an arm 402 configured to support a winch 138 (see, e.g., FIG. 1). The arm 402 may extend outwardly from a column 404 and may be rotatably coupled with the column 404. However, in contrast to the crane 100, the column 404 may be a unitary component formed from a single piece of steel tubing. In further contrast to the crane 100, the column 404 may extend through the hatch 142 (see, e.g., FIG. 3). As the column 162 extends through the hatch 142, a clamp 406 that is selectively slidable along the column 162 may engage with the hatch 142 to support the column 404 on the hatch 142. In addition, the column 404 may include a flange 408 positioned and located proximate to a lower end 410 that is configured to couple the column 404 with a step (not illustrated). For example, the flange 408 may include a plurality of fastening holes (not illustrated) that are configured to receive a fastener to couple the flange 408 with the step.

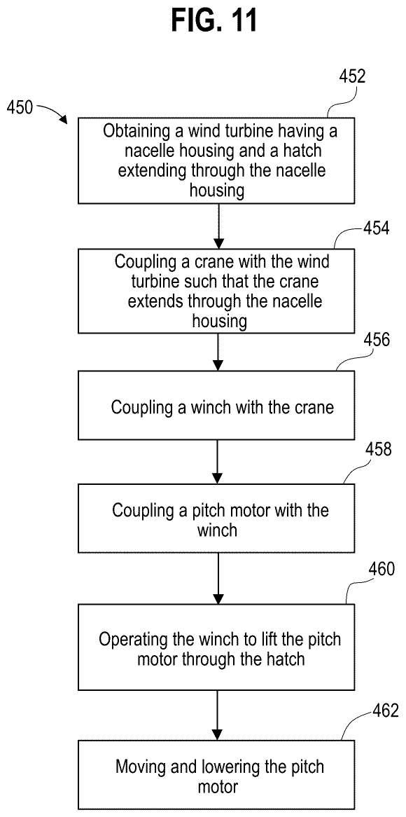

Turning now to FIG. 11, a method 450 of lifting, raising, or moving a pitch motor or other object for a wind turbine will be described in greater detail in accordance with select embodiments of the present invention. As described above, the method 450 can be utilized by maintenance technicians to help install or replace a pitch motor for a wind turbine (see, e.g., FIG. 1). The method 450 may also be suitably used or adapted to move any number of different objects (such as parts, components, equipment and/or machinery) that are either installed or replaced on a wind turbine or used for the installation, replacement and/or maintenance of a wind turbine or part or component associated therewith. The following description of method 450 is described with respect to a pitch motor; however, it can be used with any suitable object.

The method comprises steps 452-462. In particular, at step 452, the method 450 may include obtaining or selecting a wind turbine (e.g., the wind turbine 102) having a nacelle housing and a hatch extending through the nacelle housing. Next, at step 454, the method 450 may include coupling a crane (e.g., the crane 100 or the crane 400) with the wind turbine such that the crane extends through the nacelle housing. For example, the step 454 may include inserting a lower end of the crane in a bearing casing and positioning the crane such that a column extending along a central axis passes through the wind turbine. In addition, the step 454 may further include rotating at least one fastener to engage a gasket with the nacelle housing. Then, at step 456, the method 450 may include coupling a winch with the crane, and at step 458, the method 450 may include coupling the pitch motor with the winch. The step 458 may further include rotating an arm of the crane to position the winch above the hatch. Next, at step 460, the method 450 may include operating the winch to lift the pitch motor through the hatch. Then, at step 462, the method 450 may include moving and lowering the pitch motor. The step 462 of moving and lowering the pitch motor may include rotating the arm to position the pitch motor over a roof of the nacelle housing and operating the winch to lower the pitch motor.

In certain embodiments, the method 450 may comprise only steps 452 and 458-462. In such embodiments, the method step 452 may comprise obtaining or selecting a wind turbine having a nacelle housing with a hatch and a crane installed adjacent thereto, wherein the crane includes a winch. After the step 452, the method 450 may comprise the step 458 of coupling the pitch motor with the winch and the step 460 of operating the winch to lift the pitch motor through the hatch. In some such embodiments, the step 458 or the step 460 may further comprise a step of rotating a door to place the hatch in an open configuration, a step of inspecting the crane before coupling the pitch motor with the winch, and a step of providing power to the winch. Then, at step 462, the method 450 may include moving and lowering the pitch motor.

Further embodiments of cranes may have different configurations, components, or dimensions than those specified above. In addition, further embodiments of methods for lifting or raising a pitch motor or other object may include different combinations of steps or sequences of steps than those specified above. The present invention is by no means limited to the above described preferred embodiments thereof. The rights sought are defined by the following claims within the scope of which many modifications can be envisaged.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

As used herein, the terms “about” and “approximately” when referring to a measurable value such as an amount, a temporal duration, and the like, can include variations of +/−20%, more preferably +/−10%, even more preferably +/−5% from the specified value, as such variations are appropriate to reproduce the disclosed methods and systems.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A crane configured for a wind turbine including a nacelle with a nacelle hatch, the crane comprising:
a post configured to couple the crane with the nacelle of the wind turbine;
a step coupled with the post, the step sized and shaped such that at least a portion of the step is positioned and located below the nacelle hatch when the post is coupled with the nacelle of the wind turbine;
a column extending away from the step; and
an arm coupled with the column, wherein the arm is selectively rotatable about the column to position a distal end of the arm above the nacelle hatch.

2. The crane of claim 1, wherein the column extends along a first axis, and wherein the post extends along a second axis that is oriented parallel to the first axis.

3. The crane of claim 2, wherein an outer edge of the step is positioned and located between about 5 inches and about 18 inches from the first axis.

4. The crane of claim 1, wherein the column includes a lower section and an upper section coupled together by a joint, the joint received in each of the upper section and the lower section.

5. The crane of claim 1 further comprising a gasket assembly coupled with the column and configured to selectively engage with the nacelle of the wind turbine.

6. The crane of claim 1, wherein the arm is configured to couple with a winch proximate to the distal end.

7. The crane of claim 1, further comprising:
a shaft having a lower region and an upper region, the lower region coupled with the column;
a bearing coupled with the upper region; and
a housing coupled with the arm and supported on the shaft by the bearing.

8. A crane including;
a post oriented along a first axis;
a platform supported by the post;
a column coupled with the platform and oriented along a second axis; and
an arm protruding outwardly from the column to a distal end, wherein an aperture extends through the arm proximate to the distal end;
wherein the post and the column are positioned and located on the platform such that a distance between the first axis and the second axis is between about 42% and about 72% of a total length of the platform.

9. The crane of claim 8, wherein the distance between the first axis and the second axis is between about between about 2 inches and about 13 inches.

10. The crane of claim 8, where a distance between the aperture and the second axis is between about 5 inches and about 25 inches.

11. The crane of claim 8, wherein:
the aperture is positioned and located a first distance from the second axis;
an outer edge of the platform is positioned and located a second distance from the second axis; and
the first distance is greater than the second distance.

12. The crane of claim 8 further comprising treads formed on an upper surface of the platform.

13. The crane of claim 8, wherein the column includes an upper section and a lower section coupled together by a joint, the joint including a flange configured to support the upper section on the joint.

14. The crane of claim 13, wherein the flange is further configured to support the joint on the lower section.

15. A method of lifting a pitch motor, the method comprising steps of:
selecting a wind turbine having a nacelle housing and a hatch extending through the nacelle housing;
coupling a crane with the wind turbine such that the crane extends through the nacelle housing;
coupling a winch with the crane;
coupling the pitch motor with the winch; and
operating the winch to lift the pitch motor through the hatch.

16. The method of claim 15, wherein the step of coupling the crane with the wind turbine comprises inserting a lower end of the crane in a bearing casing.

17. The method of claim 15, wherein the step of coupling the crane with the wind turbine comprises rotating at least one fastener to engage a gasket with the nacelle housing.

18. The method of claim 15, wherein the step of coupling the pitch motor with the winch comprises rotating an arm of the crane to position the winch above the hatch.

19. The method of claim 15 further comprising steps of:
rotating an arm of the crane to position the pitch motor over a roof of the nacelle housing; and
operating the winch to lower the pitch motor.

20. The method of claim 15, wherein the step of coupling the crane with the wind turbine comprises positioning the crane such that a column extending along a central axis passes through the wind turbine, wherein the central axis is positioned and located between about 4 inches and about 10 inches from an edge the hatch.
